(19) United States
(12) Patent Application Publication
(10) Pub. No.: US 2026/0175155 A1
(43) Pub. Date: Jun. 25, 2026

(54) REGENERABLE HgCl2 STANDARD GAS GENERATING AGENT, AND PREPARATION METHOD AND APPLICATION THEREOF

(71) Applicant: SOUTHEAST UNIVERSITY, Nanjing (CN)

(72) Inventors: Yufeng DUAN, Nanjing (CN); Yuxing Zhou, Nanjing (CN); Haiyang Li, Nanjing (CN); Jiangyi Tong, Nanjing (CN)

(73) Assignee: SOUTHEAST UNIVERSITY, Nanjing (CN)

(21) Appl. No.: 19/539,017

(22) Filed: Feb. 13, 2026

Related U.S. Application Data
(63) Continuation of application No. PCT/CN2024/099756, filed on Jun. 18, 2024.

(30) Foreign Application Priority Data
Aug. 21, 2023 (CN) 202311055490.0

(51) Int. Cl. B01D 53/02; B01D 53/30; B01D 53/75

(52) U.S. Cl. CPC B01D 53/02; B01D 53/30; B01D 53/75; B01D 2257/602

(57) ABSTRACT

A regenerable HgCl₂ standard gas generating agent, and a preparation method and application thereof are provided. The method includes: dissolving a transition metal chloride in water to produce a solution; adding a non-carbon-based support material into the solution and mixing evenly to produce a mixture; performing suction filtration and drying treatment on the mixture to produce an HgCl₂ generating agent. The HgCl₂ standard gas generating agent uses the transition metal chloride as active component and the non-carbon-based substance as active component and dispersion support. The method further proposes performing further modification through low-temperature plasma to increase the content of the active component, and further proposes restoring the chemical activity of the HgCl₂ standard gas generating agent through low-temperature plasma treatment for the purpose of regeneration.

### CROSS REFERENCE TO THE RELATED APPLICATIONS

This application is a continuation application of International Application No. PCT/CN2024/099756, filed on Jun. 18, 2024, which is based upon and claims priority to Chinese Patent Application No. 202311055490.0, filed on Aug. 21, 2023, the entire contents of which are incorporated herein by reference.

### TECHNICAL FIELD

The present disclosure belongs to the field of calibration technologies of online mercury monitoring systems for coal-fired flue gas or mercury-containing flue gas generated by other industries, and specifically relates to a regenerable HgCl₂ standard gas generating agent and a preparation method thereof, and further relates to an application of an HgCl₂ standard gas generating agent in an online mercury monitoring system for mercury-containing flue gas. Furthermore, with the HgCl₂ standard gas generating agent as a chlorine source and elemental mercury Hg⁰ as a mercury source, an HgCl₂ standard gas is generated through gas-solid chemical reaction for use in an HgCl₂ standard gas calibration module in the online mercury monitoring system.

### BACKGROUND

Mercury has acute toxicity, non-degradability and bio-accumulation and can pose severe harm to the human and natural environment. Along with the signing and implementation of the Minamata Convention on Mercury, various regions have launched stricter mercury discharge standards, leading to urgent requirement to carry out effective control and real-time monitoring on the mercury discharge in the coal-fired flue gas or the mercury-containing flue gas generated by other industries.

Nowadays, there are three detection methods for mercury in the industrial mercury-containing flue gas: (1) wet chemical sampling method (OHM), (2) adsorption tube offline sampling method (EPA Method 30B), and (3) online mercury continuous monitoring system (Hg-CEMS). The online mercury continuous monitoring system is a complete set of equipment integrating continuous collection and online monitoring of flue gas mercury discharge concentration, which is a flue gas mercury monitoring method which now features rapid development and advanced technology. This system includes a flue gas sampling pre-treatment syst4em, mercury speciation separation and conversion system, a mercury analysis module, a calibration module and a data collection and transmission module.

The Hg-CEMS standard gas calibration module system includes an Hg⁰ standard gas generation device and an Hg²⁺ standard gas generation device, which are used respectively to stably supply Hg⁰ standard gas and Hg²⁺ standard gas to the flue gas pre-treatment device and the mercury detection module. The standard gas is supplied to the flue gas pre-treatment module to detect the reliability and stability of the mercury separation and conversion unit and the thermal dilution unit, which is called external standard; the standard gas is supplied to the mercury detection module to detect the stability and reliability of the mercury analysis light path detection module, which is called internal standard. Therefore, the standard gas generating device in the Hg-CEMS system becomes a key core technology for effectively ensuring the monitoring data quality control and accuracy control of the Hg-CEMS system.

The patent CN102500203B discloses a generation device of a divalent mercury in a simulated flue gas and an application thereof. This device, through a peristaltic pump, evaporates an HgCl₂ solution prepared with a concentration and then is mixed with a dilution gas to produce a desired HgCl₂ standard gas. This method can generate the HgCl₂ standard gas, but possible harm is posed to the operators during HgCl₂ solution preparation and use; and the method requires tedious operations and the concentration of the HgCl₂ standard gas is limited by the solution evaporation temperature, easily leading to instability. The patent Ser. No. 10/588,6796A discloses a device for generating a mercury and divalent mercury standard gas based on saturation principle. With Hg⁰ as mercurty source, and O₂, HCl, Cl₂ or H₂O as oxidant, the device oxidizes Hg⁰ into HgCl₂ or HgO under plasma discharge. Although the present disclosure can generate the divalent standard gas under a low temperature, a large quantity of impurity gases exist in the HgCl₂ standard gas, unable to satisfy the technical requirements of the Hg-CEMS for the HgCl₂ standard gas.

In view of this, the present disclosure provides a high-purity, low-impurity, and continuously stable HgCl₂ standard gas generating agent and a preparation method thereof, which can satisfy the technical requirements of the HgCl₂ standard gas and application in the online mercury continuous monitoring (Hg-CEMS) system.

### SUMMARY

One of the objects of the present disclosure is to provide a preparation method of a high-purity, low-impurity, and continuously stable HgCl₂ standard gas generating agent.

The second of the objects of the present disclosure is to provide a high-purity, low-impurity, and continuously stable HgCl₂ standard gas generating agent.

The third of the objects of the present disclosure is to provide an application of the HgCl₂ standard gas generating agent in the online mercury online monitoring system for mercury-containing flue gas.

In order to realize one of the objects of the present disclosure, the following technical scheme is employed:
S1, dissolving a transition metal chloride in water to produce a solution;
S2, adding a non-carbon-based support material into the solution and mixing evenly to produce a mixture;
S3, performing suction filtration and drying treatment in sequence on the mixture to produce an HgCl₂ standard gas generating agent;
S4, performing regeneration on the spent HgCl₂ standard gas generating agent through low-temperature plasma treatment.

In the above preparation method, firstly, the aqueous solution of the transition metal chloride is prepared, and then, the non-carbon-based support material is added into the solution to realize supporting for the transition metal chloride. The non-carbon-based support used in the present disclosure exhibits almost no adsorption to the Hg⁰ and generated HgCl₂, which ensures the generated HgCl₂ standard gas has high purity and contains no impurity gases. Some metal cations can be supported in low valence in an impregnation process, leading to the problem of poor oxidation efficiency. In view of this, in the present disclosure, the prepared HgCl₂ generating agent is modified through low-temperature plasma under the condition of HCl or Cl₂ to strengthen the HgCl₂ conversion efficiency and purity. In the above modification process, the low-valence metal cations are oxidized under the action of high-energy electrons into high-valence metal cations, and further, the content of the active Cl ions can be increased and the oxidation effect of the HgCl₂ generating agent can be improved.

Furthermore, in the step S1, the mass concentration of the transition metal chloride in the solution is 1 wt. % to 30 wt. %, and preferably, the mass concentration of the transition metal chloride in the solution is 5 to 20 wt. %.

Furthermore, in the step S1, the transition metal chloride is selected from combination of one or more of FeCl₃, CuCl₂, and MnCl₂, and preferably, the transition metal chloride is CuCl₂.

Furthermore, in the step S2, the non-carbon-based support material is selected from combination of one or more of porous Al₂O₃, mesoporous SiO₂, TiO₂, zeolite, and MCM-41 molecular sieve. Preferably, the non-carbon-based support material is γ-Al₂O₃ and/or MCM-41 molecular sieve, and compared with other supports, both of them have mesoporous channels and high specific surface area favorable for Hg⁰ and HgCl₂ dispersion, which enable the active components to be be highly dispersed on its surface. More preferably, the non-carbon-based support material is MCM-41 molecular sieve which has higher specific surface area and more homogeneous mesoporous channel structure.

Furthermore, in the step S2, the mass volume ratio of the non-carbon-based support material to the solution is 1: (5 to 20) g/mL, which helps increase the generation efficiency of the HgCl₂.

Furthermore, in the step S2, the non-carbon-based support material is added into the solution and then placed in a magnetic stirrer and stirred for 4 to 8 h to realize full supporting and obtain a mixture.

Furthermore, in the step S3, excess moisture in the mixture is removed through suction filtration to obtain a half-dried HgCl₂ generating agent; further, the HgCl₂ generating agent is dried under the temperature of 100 to 110° C. for 2 to 24 h to obtain a fully-dried HgCl₂ generating agent.

Furthermore, the step S3 further includes: with HCl and/or Cl₂ as a modifying gas, performing low-temperature plasma modification on the HgCl₂ generating agent.

Furthermore, the low-temperature plasma modification uses a dielectric barrier discharge, the concentration of the modifying gas is 10 to 10000 ppm, the modifying time is 0.5 to 60 min and the discharge power is 5 to 300 W. Preferably, the concentration of the modifying gas is 100 to 10000 ppm, the modifying time is 5 to 30 min, and the discharge power is 30 to 200 W.

In the present disclosure, Cl free radicals and active chlorine are generated through low-temperature plasma, and under the action of charge exchange, the valence state of the metal cations is converted from low valence to high valence and meanwhile, the generated active chlorine is supported on the support surface to enable it to have higher reactivity, promoting the conversion of Hg⁰ to HgCl₂.

Furthermore, in the step S4, the regeneration is performed with HCl and/or Cl₂ as a regeneration gas with a concentration of 100 to 4000 ppm for a regeneration time of 5 to 60 min under a discharge power of 60 to 400 W.

In order to realize the second of the objects of the present disclosure, the following technical scheme is employed: there is provided a low-temperature plasma-modified HgCl₂ generating agent, where the low-temperature plasma-modified HgCl₂ generating agent is prepared by the preparation method according to one of the objects of the present disclosure.

In order to realize the third of the objects of the present disclosure, there is provided an application of the low-temperature plasma-modified HgCl₂ generating agent, which includes: applying the low-temperature plasma-modified HgCl₂ generating agent to an online mercury monitoring system for coal-fired flue gas or mercury-discharge flue gas in other industries to realize stable generation of the HgCl₂ standard gas.

In some preferred embodiments, the above HgCl₂ standard gas generating agent is applied to a calibration module of the Hg-CEMS system. The Hg-CEMS system has two solutions for standard gas calibration: In the first solution, internal standard calibration is performed on the Hg-CEMS system, namely, Hg⁰ carrier gas is separately introduced into the thermal dilution module or the mercury detection module; in the second solution, external standard calibration is performed on the Hg-CEMS system, namely, Hg⁰ carrier gas performs oxidation reaction with the HgCl₂ generating agent in the present disclosure to produce the HgCl₂ standard gas. In the use of the HgCl₂ generating agent provided by the present disclosure, there is no need to further add other gases (such as Cl₂, Cl₂+HCl, and HCl and so on) as chlorine sources, and the efficient oxidation of Hg⁰ can be realized under the pure N₂ atmosphere. When it is applied to the calibration system of the Hg-CEMS, the impact of additionally-introduced HCl or Cl₂ on the HgCl₂ standard gas can be avoided.

Furthermore, the HgCl₂generating agent provided by the present disclosure can also be applicable to the stable generation of the HgCl₂ standard gas in the laboratories.

Furthermore, the application of the low-temperature plasma-modified HgCl₂ generating agent provided by the present disclosure further includes performing low-temperature plasma treatment on the HgCl₂ generating agent for regeneration. The spent HgCl₂ generating agent is treated through low-temperature plasma for a time under the condition of HCl and/or Cl₂ to enable its oxidation efficiency to increase to the desired level again.

Preferably, in the treatment regeneration process with the low-temperature plasma, the concentration of HCl and/or Cl₂ is 100 to 4000 ppm, the power is 60 to 400 W, and the gas introduction time is 5 to 60 min.

Compared with the prior arts, the present disclosure has the following beneficial effects.

(1) In the preparation method of the HgCl₂ generating agent in the present disclosure, with the transition metal chloride as active component and the non-carbon-based substance as active component and dispersion support, the HgCl₂ standard gas generating agent can be prepared. Through the low-temperature plasma modification, the content of the active component can be further increased and the generation efficiency of the HgCl₂ standard gas generating agent can be improved. The HgCl₂ generating agent prepared in the present disclosure can efficiently oxidize Hg⁰ into HgCl₂ to realize continuous and stable generation of the high-purity and low-impurity HgCl₂ standard gas. There is no need to further add other gases (such as Cl₂, Cl₂+HCl, and HCl and so on) as chlorine sources, and the efficient oxidation of Hg⁰ can be realized under the pure N₂ atmosphere. When it is applied to the calibration system of the Hg-CEMS, the impact of additionally-introduced HCl or Cl₂ on the HgCl₂ standard gas can be avoided. Compared with the solution evaporation method, it has the advantages of high safety, good material availability, high generation stability and high efficiency and so on.

(2) The HgCl₂ generating agent prepared in the present disclosure can be applied to the online mercury monitoring system for coal-fired flue gas or mercury-containing flue gas in other industries to realize stable generation of the HgCl₂ standard gas and can also be applied to the stable generation of the HgCl₂ standard gas in the laboratories. Compared with the conventional method of oxidizing Hg⁰ with Cl₂, Cl₂+HCl, and HCl as chlorine sources and the plasma oxidation method, the HgCl₂ generating agent prepared in the present disclosure has the advantages of high HgCl₂ standard gas generation rate, high oxidation rate and no impurity in the generated standard gas and so on, and the preparation method is simple, stable and reliable, and can produce high-purity and high-safety HgCl₂ standard gas. The present disclosure provides technical support for monitoring data quality control and accuracy control of the online mercury continuous monitoring system (Hg-CEMS), bringing broad promotion and application value.

### BRIEF DESCRIPTION OF THE DRAWINGS

FIG. 1 is a flowchart illustrating a preparation method of a regenerable HgCl₂ standard gas generating agent according to an example of the present disclosure.

FIGS. 2A-2B show a mercury oxidation rate (FIG. 2A) and a mercury balance rate (FIG. 2B), under different temperatures, of the HgCl₂ generating agent prepared in an example 1 of the present disclosure.

FIG. 3 is a comparison diagram of over-time change of the mercury oxidation rate of the HgCl₂generating agent modified through low-temperature plasma in an example 2 of the present disclosure and the unmodified HgCl₂ generating agent in the example 1.

FIG. 4 is a diagram of over-time change of the mercury oxidation rate of the HgCl₂ generating agent modified through low-temperature plasma in an example 3 of the present disclosure.

FIG. 5 is a diagram of over-time change of the mercury oxidation rate of the HgCl₂ standard gas generating agent prepared in the example 2, which goes through plasma regeneration treatment after being spent.

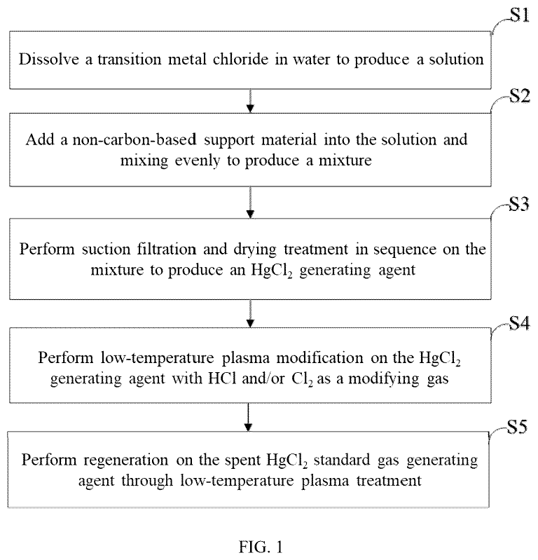

### DETAILED DESCRIPTION OF THE EMBODIMENTS

The technical solutions of the present disclosure will be fully and clearly described below by way of examples. Apparently, the described examples are only some examples of the present disclosure rather than all examples. All other examples obtained by persons of ordinary skills in the arts based on these examples of the present disclosure without carrying out creative work shall all fall within the scope of protection of the present disclosure.

It should be noted that in case of no conflicts, the examples of the present disclosure and the features of the examples can be mutually combined.

Further descriptions are made below to the present disclosure in combination with specific examples and shall not be used as limitation to the present disclosure.

The main parameters in the examples and control examples of the present disclosure are shown in Table 1 below.

TABLE 1

| | Active components | | Supports | | Low-temperature plasma | | | |
|---|---|---|---|---|---|---|---|---|
| | Metal | Solution | Support | Support/ | Modifying | | Modifying | Discharge |
| | chloride | concentration | material | solution | gas | Concentration | time | power |
| Examples | Type | wt. % | Type | g/mL | Type | ppm | min | W |
| Example 1 | CuCl₂ | 10 | γ-Al₂O₃ | 1:10 | | | | |
| Example 2 | CuCl₂ | 10 | γ-Al₂O₃ | 1:10 | HCl | 2000 | 3 | 30 |
| Example 3 | CuCl₂ | 10 | Mesoporous | 1:5 | Cl₂ | 10 | 30 | 160 |
| | | | silica | | | | | |
| Example 4 | MnCl₂ | 25 | TiO₂ | 1:20 | HCl | 10000 | 0.5 | 300 |
| Example 5 | FeCl₃ | 20 | zeolite | 1:15 | Cl₂ | 5000 | 10 | 50 |
| Example 6 | CuCl₂ | 10 | MCM-41 | 1:10 | HCl + Cl₂ | 1000 | 20 | 10 |
| | | | molecular | | | | | |
| | | | sieve | | | | | |

### Example 1

There is provided a preparation method of a regenerable HgCl₂ standard gas generating agent, which includes the following steps:

At step 1, 5 g of anhydrous CuCl₂ was weighed and dissolved in 45 ml of deionized water to obtain a CuCl₂ solution of 10 wt. %.

At step 2, 5 g of γ—Al₂O₃ was added at a solid-liquid ratio of 1 g:10 ml; after the mixture was stirred evenly, the mixture was placed in a magnetic stirrer and stirred for 5 h to obtain a mixture.

At step 3, suction filtration was performed on the mixture on a suction filtration device to obtain a half-dried HgCl₂ generating agent, and then the half-dried generating agent was placed into a drying oven and dried for 12 h at the temperature of 105° C. to obtain an HgCl₂ generating agent.

At step 4, the spent HgCl₂ standard gas generating agent was regenerated with low-temperature plasma treatment.

### Example 2

There is provided a preparation method of a regenerable HgCl₂ standard gas generating agent, which includes the following steps:

At step 1, 5 g of anhydrous CuCl₂ was weighed and dissolved in 45 ml of deionized water to obtain a CuCl₂ solution of 10 wt. %.

At step 2, 5 g ofγ-Al₂O₃ was added at a solid-liquid ratio of 1 g:10 ml; after the mixture was stirred evenly, the mixture was placed in a magnetic stirrer and stirred for 5 h to obtain a mixture.

At step 3, suction filtration was performed on the mixture on a suction filtration device to obtain a half-dried HgCl₂ generating agent, and then the half-dried generating agent was placed into a drying oven and dried for 12 h at the temperature of 105° C. to obtain an HgCl₂ generating agent.

At step 4, the dried HgCl₂ generating agent was placed into a low-temperature plasma modifying device, and low-temperature plasma modification was performed on the dried HgCl₂ generating agent with 2000 ppm HCl as modifying gas for a modifying time of 3 min under a discharge power of 30 W to obtain a low-temperature plasma-modified HgCl₂ generating agent.

At step 5, regeneration was performed on the spent HgCl₂ standard gas generating agent through low-temperature plasma treatment.

### Example 3

There is provided a preparation method of a regenerable HgCl₂ standard gas generating agent, which includes the following steps:

At step 1, 5 g of anhydrous CuCl₂ was weighed and dissolved in 45 ml of deionized water to obtain a CuCl₂ solution of 10 wt. %.

At step 2, 10 g of mesoporous SiO₂ was added at a solid-liquid ratio of 1 g:5 ml; after the mixture was stirred evenly, the mixture was placed in a magnetic stirrer and stirred for 5 h to obtain a mixture.

At step 3, suction filtration was performed on the mixture on a suction filtration device to obtain a half-dried HgCl₂ generating agent, and then the half-dried generating agent was placed into a drying oven and dried for 12 h at the temperature of 105° C. to obtain an HgCl₂ generating agent.

At step 4, the dried HgCl₂ generating agent was placed into a low-temperature plasma modifying device, and low-temperature plasma modification was performed on the dried HgCl₂ generating agent with 10 ppm Cl₂ as modifying gas for a modifying time of 30 min under a discharge power of 160 W to obtain a low-temperature plasma-modified HgCl₂ generating agent.

At step 5, regeneration was performed on the spent HgCl₂ standard gas generating agent through low-temperature plasma treatment.

### Example 4

There is provided a preparation method of a regenerable HgCl₂ standard gas generating agent, which includes the following steps:

At step 1, 15 g of MnCl₂ was weighed and dissolved in 45 ml of deionized water to obtain an MnCl₂ solution of 25 wt. %.

At step 2, 3 g of TiO₂ was added at a solid-liquid ratio of 1 g:20 ml; after the mixture was stirred evenly, the mixture was placed in a magnetic stirrer and stirred for 8 h to obtain a mixture.

At step 3, suction filtration was performed on the mixture on a suction filtration device to obtain a half-dried HgCl₂ generating agent, and then the half-dried generating agent was placed into a drying oven and dried for 18 h at the temperature of 100° C. to obtain an HgCl₂ generating agent.

At step 4, the dried HgCl₂ generating agent was placed into a low-temperature plasma modifying device, and low-temperature plasma modification was performed on the dried HgCl₂ generating agent with 10000 ppm HCl as modifying gas for a modifying time of 0.5 min under a discharge power of 300 W to obtain a low-temperature plasma-modified HgCl₂ generating agent.

At step 5, regeneration was performed on the spent HgCl₂ standard gas generating agent through low-temperature plasma treatment.

### Example 5

There is provided a preparation method of a regenerable HgCl₂ standard gas generating agent, which includes the following steps:

At step 1, 12 g of FeCl₃ was weighed and dissolved in 48 ml of deionized water to obtain an FeCl₃ solution of 20 wt. %.

At step 2, 4 g of zeolite was added at a solid-liquid ratio of 1 g:15 ml; after the mixture was stirred evenly, the mixture was placed in a magnetic stirrer and stirred for 4 h to obtain a mixture.

At step 3, suction filtration was performed on the mixture on a suction filtration device to obtain a half-dried HgCl₂ generating agent, and then the half-dried generating agent was placed into a drying oven and dried for 8 h at the temperature of 110° C. to obtain an HgCl₂ generating agent.

At step 4, the dried HgCl₂ generating agent was placed into a low-temperature plasma modifying device, and low-temperature plasma modification was performed on the dried HgCl₂ generating agent with 5000 ppm Cl₂ as modifying gas for a modifying time of 10 min under a discharge power of 50 W to obtain a low-temperature plasma-modified HgCl₂ generating agent.

At step 5, regeneration was performed on the spent HgCl₂ standard gas generating agent through low-temperature plasma treatment.

### Example 6

There is provided a preparation method of a regenerable HgCl₂ standard gas generating agent, which includes the following steps:

At step 1, 5 g of anhydrous CuCl₂ was weighed and dissolved in 45 ml of deionized water to obtain a CuCl₂ solution of 10 wt. %.

At step 2, 5 g of MCM-41 molecular sieve was added at a solid-liquid ratio of 1 g:10 ml; after the mixture was stirred evenly, the mixture was placed in a magnetic stirrer and stirred for 6 h to obtain a mixture.

At step 3, suction filtration was performed on the mixture on a suction filtration device to obtain a half-dried HgCl₂ generating agent, and then the half-dried generating agent was placed into a drying oven and dried for 12 h at the temperature of 105° C. to obtain an HgCl₂ generating agent.

At step 4, the dried HgCl₂ generating agent was placed into a low-temperature plasma modifying device, and low-temperature plasma modification was performed on the dried HgCl₂ generating agent with a mixture gas (volume ratio 1:1) of 1000 ppm HCl and Cl₂ as modifying gas for a modifying time of 20 min under a discharge power of 10 W to obtain a low-temperature plasma-modified HgCl₂ generating agent.

At step 5, regeneration was performed on the spent HgCl₂ standard gas generating agent through low-temperature plasma treatment.

### Application Example 1

The HgCl₂ standard gas generating agent prepared in the step 3 of the example 1 is placed on a fixed bed test rig to verify its ability to oxidize Hg⁰ into HgCl₂. The test conditions are: HgCl₂ generating agent 25 mg, quartz sand bed material 500 mg, mercury-laden nitrogen 200 ml/min, balance nitrogen 800 ml/min, and initial Hg⁰ concentration 1050±10 μg/m³.

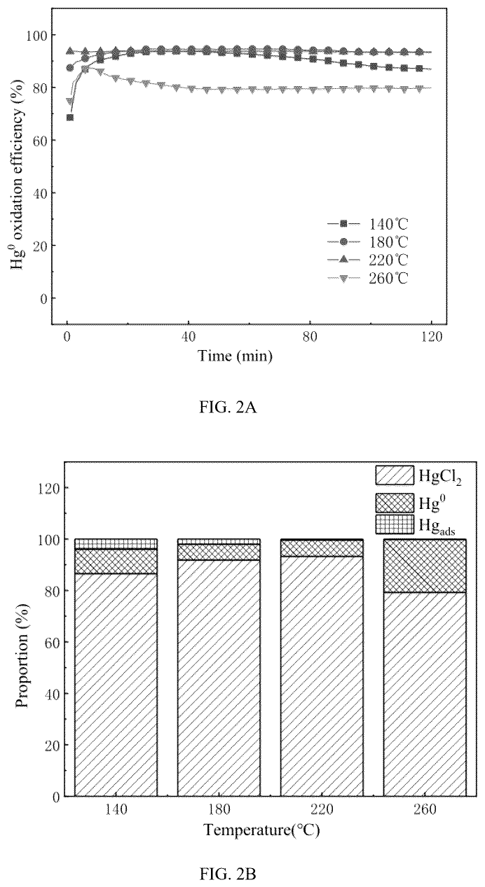

From the above FIGS. 2A-2B, it can be known that the HgCl₂ standard gas generating agent prepared in the step 3 of the example 1 has high oxidation efficiency and stable oxidation effect within a temperature range of 180 to 220° C., and the HgCl₂ generation rate within 120 min is stabilized over 90%.

### Application Example 2

On the fixed bed, the oxidation efficiency test of a long time (14 h) is performed on the low-temperature plasma-modified HgCl₂ standard gas generating agent prepared in the example 2 and the unmodified HgCl₂ standard gas generating agent prepared in the example 1. The test conditions are: low-temperature plasma-modified and low-temperature plasma-unmodified HgCl₂ generating agent 25 mg, quartz sand bed material 500 mg, mercury-laden nitrogen 200 ml/min, balance nitrogen 800 ml/min, fixed bed temperature 220° cand initial Hg⁰ concentration 1050±10 g/m³.

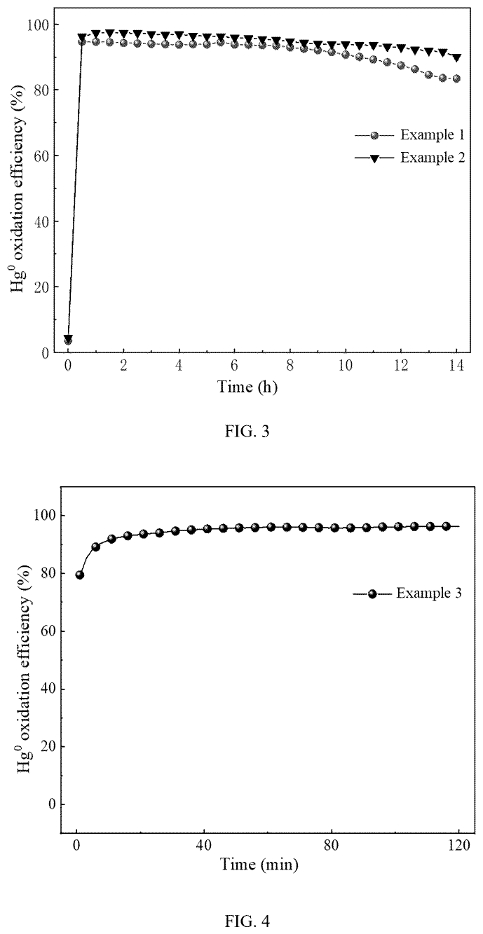

From the above FIG. 3, it can be known that the low-temperature plasma-modified HgCl₂ standard gas generating agent prepared in the example 2 is further improved in oxidation efficiency and oxidation time. Compared with the example 1, its initial oxidation efficiency is increased from 93.7% to 97.4%, and is still maintained above 90% after 14 h. The low-temperature plasma-unmodified HgCl₂ generating agent in the example 1 has an oxidation efficiency of 83.4%.

FIG. 4 is a diagram of over-time change of the mercury oxidation rate of the low-temperature plasma-modified HgCl₂ standard gas generating agent prepared in the example 3. From FIG. 4, it can be known that the Cl₂-modified oxidant prepared in the example 3 exhibits excellent oxidation efficiency and can be maintained at 96.1% within 2 h.

### Application Example 3

On the fixed bed, long-time test is performed on the low-temperature plasma-modified HgCl₂ standard gas generating agent prepared in the example 2 until full failure. Then, 400 ppmHCl is introduced as modifying gas, and low-temperature plasma discharge is performed on the HgCl₂ standard gas generating agent for 10 min under the condition of the discharge power of 160 W to perform regeneration test on the HgCl₂ standard gas generating agent, so as to verify its regeneration effect.

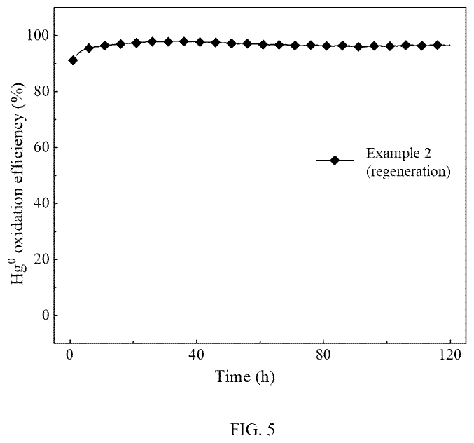

As shown in FIG. 5, the HgCl₂ standard gas generating agent subjected to plasma regeneration treatment still has high oxidation efficiency; the test with the method shown in the application example 2 shows that the oxidation efficiency still remains over 90% within 2 h, which indicates that its oxidation ability after regeneration is effectively restored.

In conclusion, the present disclosure provides an HgCl₂ standard gas generating agent and a preparation method thereof. Compared with the prior arts, the present method is easy to operate, and can stably and reliably produce high-purity and high-safety HgCl₂ standard gas, which satisfies the technical requirements of the mercury calibration module in the online mercury continuous monitoring system (Hg-CEMS), and can be applied to the online mercury continuous monitoring system, providing monitoring data quality control and accuracy control.

The above descriptions are preferred examples of the present disclosure and shall not be used to limit the implementations and the protection scope of the present disclosure. Those skilled in the arts should be aware that those solutions obtained by making the equivalent replacements and obvious changes based on the contents of the specification shall fall within the scope of protection of the present disclosure.

What is claimed is:

1. A preparation method for a regenerable HgCl₂ standard gas generating agent, comprising the following steps:
S1, dissolving a transition metal chloride in water to produce a solution;
S2, adding a non-carbon-based support material into the solution and mixing evenly to produce a mixture;
S3, performing suction filtration and drying treatment in sequence on the mixture to produce an HgCl₂ standard gas generating agent;
S4, performing regeneration on a spent HgCl₂ standard gas generating agent through low-temperature plasma treatment; wherein the regeneration is performed with HCl and/or Cl₂ as a regeneration gas with a concentration of 100 to 4000 ppm for a regeneration time of 5 to 60 min under a discharge power of 60 to 400 W;
wherein the HgCl₂ standard gas generating agent is applied to an online mercury monitoring system for mercury-containing flue gas to realize stable generation of an HgCl₂ standard gas.

2. The preparation method according to claim 1, wherein in the step S1, in the solution, a mass concentration of the transition metal chloride is 1 wt. % to 30 wt. %; the transition metal chloride is selected from combination of one or more of FeCl₃, CuCl₂, and MnCl₂.

3. The preparation method according to claim 1, wherein in the step S2, the non-carbon-based support material is selected from combination of one or more of porous Al₂O₃, mesoporous SiO₂, TiO₂, zeolite, and MCM-41 molecular sieve.

4. The preparation method according to claim 1, wherein in the step S2, a mass volume ratio of the non-carbon-based support material to the solution is 1: (5 to 20)g/mL.

5. The preparation method according to claim 1, wherein in the step S3, the suction filtration is first performed to make the mixture half-dried and then the drying treatment is performed; a temperature of the drying treatment is 100 to 110° C. and a time is 2 to 24 h.

6. The preparation method according to claim 1, wherein the step S3 further comprises: with HCl and/or Cl₂ as a modifying gas, performing low-temperature plasma modification on the HgCl₂ generating agent to improve a chemical activity of the HgCl₂ generating agent; the low-temperature plasma modification uses a dielectric barrier discharge, a concentration of the modifying gas is 10 to 10000 ppm, a modifying time is 0.5 to 60 min and a discharge power is 5 to 300 W.

7. A regenerable HgCl₂ standard gas generating agent, wherein the HgCl₂ generating agent is prepared by the preparation method according to claim 1.

8. An application of a regenerable HgCl₂ standard gas generating agent, wherein the HgCl₂ generating agent is prepared by the preparation method according to claim 1; with the HgCl₂ standard gas generating agent as a chlorine source and elemental mercury Hg⁰ as a mercury source, a high-purity HgCl₂ standard gas without impurities is generated through gas-solid chemical reaction under nitrogen atmosphere.

9. The regenerable HgCl₂ standard gas generating agent according to claim 7, wherein in the step S1 of the preparation method, in the solution, a mass concentration of the transition metal chloride is 1 wt. % to 30 wt. %; the transition metal chloride is selected from combination of one or more of FeCl₃, CuCl₂, and MnCl₂.

10. The regenerable HgCl₂ standard gas generating agent according to claim 7, wherein in the step S2 of the preparation method, the non-carbon-based support material is selected from combination of one or more of porous Al₂O₃, mesoporous SiO₂, TiO₂, zeolite, and MCM-41 molecular sieve.

11. The regenerable HgCl₂ standard gas generating agent according to claim 7, wherein in the step S2 of the preparation method, a mass volume ratio of the non-carbon-based support material to the solution is 1: (5 to 20)g/mL.

12. The regenerable HgCl₂ standard gas generating agent according to claim 7, wherein in the step S3 of the preparation method, the suction filtration is first performed to make the mixture half-dried and then the drying treatment is performed; a temperature of the drying treatment is 100 to 110° C. and a time is 2 to 24 h.

13. The regenerable HgCl₂ standard gas generating agent according to claim 7, wherein in the preparation method, the step S3 further comprises: with HCl and/or Cl₂ as a modifying gas, performing low-temperature plasma modification on the HgCl₂generating agent to improve a chemical activity of the HgCl₂ generating agent; the low-temperature plasma modification uses a dielectric barrier discharge, a concentration of the modifying gas is 10 to 10000 ppm, a modifying time is 0.5 to 60 min and a discharge power is 5 to 300 W.

14. The application according to claim 8, wherein in the step S1 of the preparation method, in the solution, a mass concentration of the transition metal chloride is 1 wt. % to 30 wt. %; the transition metal chloride is selected from combination of one or more of FeCl₃, CuCl₂, and MnCl₂.

15. The application according to claim 8, wherein in the step S2 of the preparation method, the non-carbon-based support material is selected from combination of one or more of porous Al₂O₃, mesoporous SiO₂, TiO₂, zeolite, and MCM-41 molecular sieve.

16. The application according to claim 8, wherein in the step S2 of the preparation method, a mass volume ratio of the non-carbon-based support material to the solution is 1: (5 to 20)g/mL.

17. The application according to claim 8, wherein in the step S3 of the preparation method, the suction filtration is first performed to make the mixture half-dried and then the drying treatment is performed; a temperature of the drying treatment is 100 to 110° C. and a time is 2 to 24 h.

18. The application according to claim 8, wherein in the preparation method, the step S3 further comprises: with HCl and/or Cl₂ as a modifying gas, performing low-temperature plasma modification on the HgCl₂ generating agent to improve a chemical activity of the HgCl₂ generating agent; the low-temperature plasma modification uses a dielectric barrier discharge, a concentration of the modifying gas is 10 to 10000 ppm, a modifying time is 0.5 to 60 min and a discharge power is 5 to 300 W.
